(19) United States
(12) Patent Application Publication
(10) Pub. No.: US 2023/0196097 A1
(43) Pub. Date: Jun. 22, 2023

(54) RANKING FUNCTION GENERATING APPARATUS, RANKING FUNCTION GENERATING METHOD AND PROGRAM

(71) Applicant: NIPPON TELEGRAPH AND TELEPHONE CORPORATION, Tokyo (JP)

(72) Inventors: Hitoshi SHIMIZU, Tokyo (JP); Tomoharu IWATA, Tokyo (JP)

(73) Assignee: NIPPON TELEGRAPH AND TELEPHONE CORPORATION, Tokyo (JP)

(21) Appl. No.: 17/924,923

(22) PCT Filed: May 18, 2020
(86) PCT No.: PCT/JP2020/019630

§ 371 Date: Nov. 11, 2022

(51) Int. Cl. G06N 3/08

(52) U.S. Cl. CPC G06N 3/08

(57) ABSTRACT

A ranking function generating apparatus includes a memory and a processor configured to execute producing training data including at least a first search log related to a first item included in a search result of a search query, a second search log related to a second item included in the search result, and respective domains of the first search log and the second search log; and learning, using the training data, parameters of a neural network that implements ranking functions for a plurality of domains through multi-task learning regarding each of the domains as a task.

### TECHNICAL FIELD

The present invention relates to a ranking function generating apparatus, a ranking function generating method, and a program.

### BACKGROUND ART

As a technology for improving ranking of items with respect to search queries in a search system, a technology of using training data on a plurality of domains to generate a ranking function is known (PTL 1).

### CITATION LIST

### Patent Literature

[PTL 1] Japanese Patent No. 5,211,000

### SUMMARY OF THE INVENTION

### Technical Problem

However, since the technology described in PTL 1 mentioned above generates a plurality of ranking functions, parameters used when these ranking functions are integrated need to be determined using a method such as cross-validation.

An aspect of the present invention has been devised in view of the foregoing point, and an object thereof is to generate ranking functions for a plurality of domains.

### Means for Solving the Problem

To attain the object, a ranking function generating apparatus according to the aspect includes a training data production unit configured to produce training data including at least a first search log related to a first item included in a search result of a search query, a second search log related to a second item included in the search result, and respective domains of the first search log and the second search log; and a learning unit configured to learn, using the training data, parameters of a neural network that implements ranking functions for a plurality of domains through multi-task learning regarding each of the domains as a task.

### Effects of the Invention

Ranking functions for a plurality of domains can be generated.

### BRIEF DESCRIPTION OF DRAWINGS

FIG. 1 is a diagram illustrating an example of a functional configuration of a ranking function generating apparatus according to the present embodiment.

FIG. 2 is a diagram illustrating an example of a search log DB.

FIG. 3 is a diagram illustrating an example of a relational feature value DB FIG. 4 is a diagram illustrating an example of a case DB.

FIG. 5 is a diagram illustrating an example of a training pair DB.

FIG. 6 is a diagram illustrating an example of a configuration of a neural network that implements a ranking function.

FIG. 7 is a flow chart illustrating an example of processing of generating the ranking function according to the present embodiment.

FIG. 8 is a diagram illustrating an example of a hardware configuration of the ranking function generating apparatus according to the present embodiment.

### DESCRIPTION OF EMBODIMENTS

In the following, an embodiment of the present invention will be described. In the present embodiment, a ranking function generating apparatus 10 capable of generating ranking functions for a plurality of domains will be described. More specifically, the ranking functions for the plurality of domains are implemented by a common neural network, and the ranking function generating apparatus 10 learns parameters of the neural network through multi-task learning to generate the ranking functions for the plurality of domains. Note that the ranking function is a function that receives as input a feature value (hereinafter referred to as the “feature value of an item”) of a combination of a search query and the item, and outputs a rank of the item with respect to the search query.

Hereinafter, a situation is assumed in which a plurality of types of search logs (i.e., search logs for a plurality of domains) can be acquired in a search system, and ranking functions corresponding to the types of these search logs are implemented by a common neural network. In addition, as the search system, an EC (Electronic Commerce) site or the like is assumed, and the types of the search logs (i.e., the domains of the search logs) are assumed to be categorized by behaviors of a user toward the items (e.g., a commercial product).

It is assumed that the behaviors of the user include three behaviors which are a behavior (click) of selecting an item from a search result of the search query, a behavior (cart) of adding, into a cart, the item from the search result or on an item detail screen after the selection of the item (i.e., adding the item included in the search result into the cart) or the like, and a behavior (conversion) of purchasing the item in the cart. Accordingly, it is assumed that there are three types of the search logs which are a search log related to the user behavior “click”, a search log related to the user behavior “cart”, and a search log related to the user behavior “conversion”.

However, the search system is not limited to the EC site, and the present embodiment can search for any item, and is applicable to any search system capable of acquiring search logs for a plurality of domains.

<Functional Configuration>

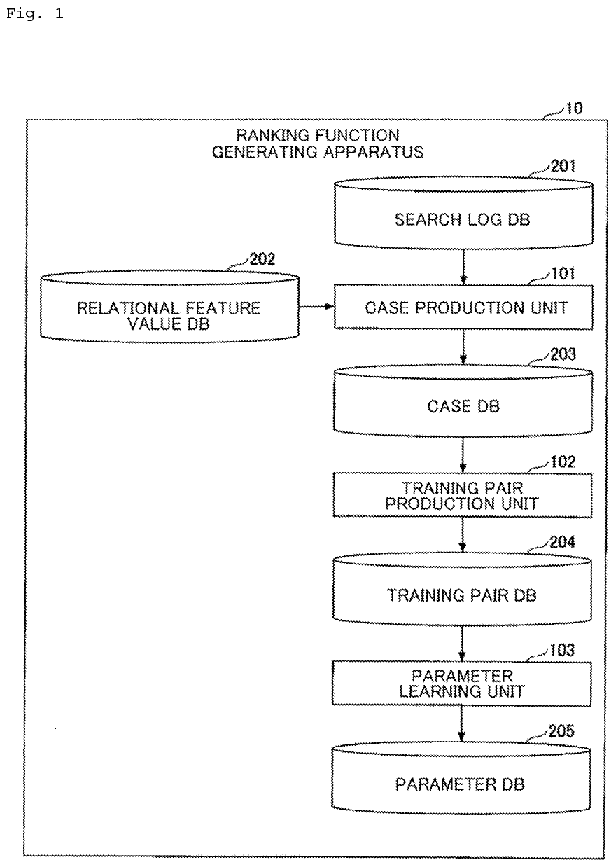

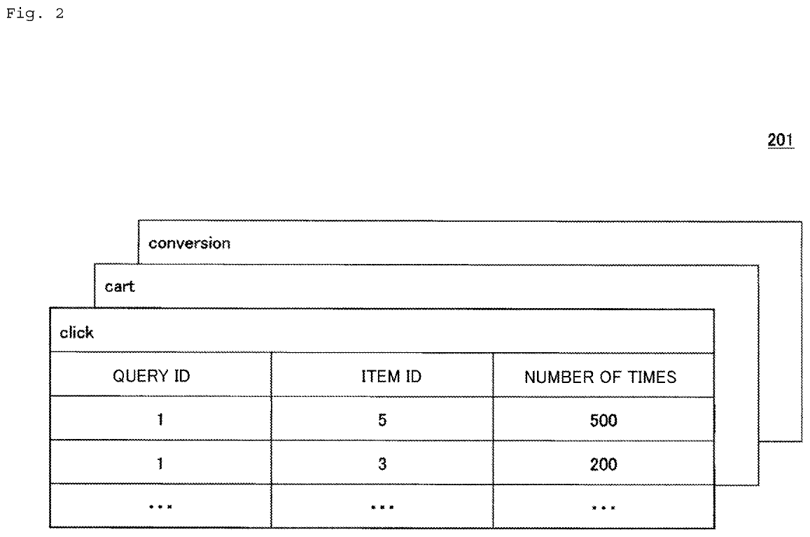

First, referring to FIG. 1, a functional configuration of the ranking function generating apparatus 10 according to the present embodiment will be described. FIG. 1 is a diagram illustrating an example of the functional configuration of the ranking function generating apparatus 10 according to the present embodiment.

As illustrated in FIG. 1, the ranking function generating apparatus 10 according to the present embodiment includes a case production unit 101, a training pair production unit 102, and a parameter learning unit 103. The ranking function generating apparatus 10 according to the present embodiment also includes a search log DB 201, a relational feature value DB 202, a case DB 203, a training pair DB 204, and a parameter DB 205.

The case production unit 101 uses search log data stored in the search log DB 201 and relational feature value data stored in the relational feature value DB 202 to produce case data to be stored in the case DB 203.

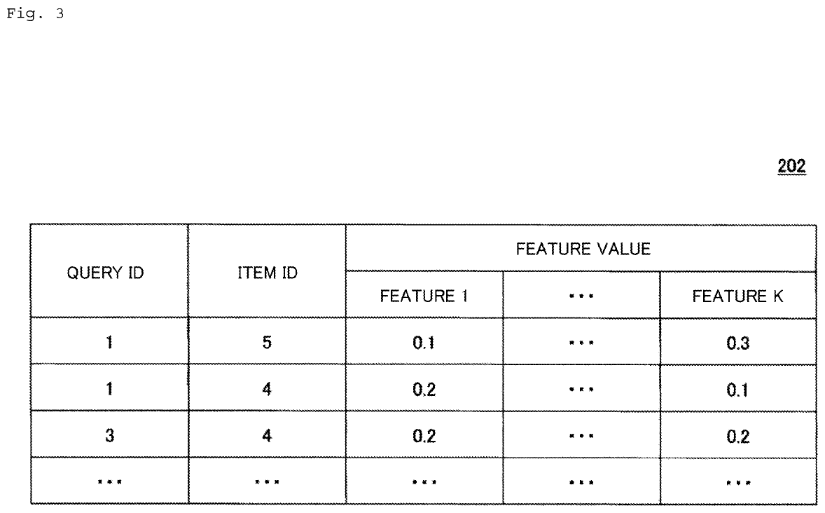

Here, referring to FIG. 2, the search log data stored in the search log DB 201 will be described. FIG. 2 is a diagram illustrating an example of the search log DB 201.

As illustrated in FIG. 2, in the search log DB 201, one or more records of search log data each representing a search log related to a user behavior “click”, one or more records of search log data each representing a search log related to a user behavior “cart”, and one or more records of search log data each representing a search log related to a user behavior “conversion” are stored. Each record of the search log data includes a query ID, an item ID, and the number of times. Here, the query ID is an ID for uniquely identifying a search query, and the item ID is an ID for uniquely identifying an item. The number of times is the number of times that, after a search was performed using the search query having the query ID, a corresponding user behavior was performed with respect to the item having the item ID.

For example, a record of the search log data related to the user behavior “click” in the first row includes a query ID “1”, an item ID “5”, and the number of times “500”. This represents that, in a search result of the search query having the query ID “1”, the user behavior “click” was performed for a total of 500 times with respect to the item having the item ID “5”. Note that the same applies also to records of search log data related to the other user behaviors.

As such, each record of the search log data stored in the search log DB 201 is information representing, for each of the query IDs and the item IDs, the number of times the corresponding user behavior was performed with respect to the item having the item ID among the items included in the search result of the search query having the query ID.

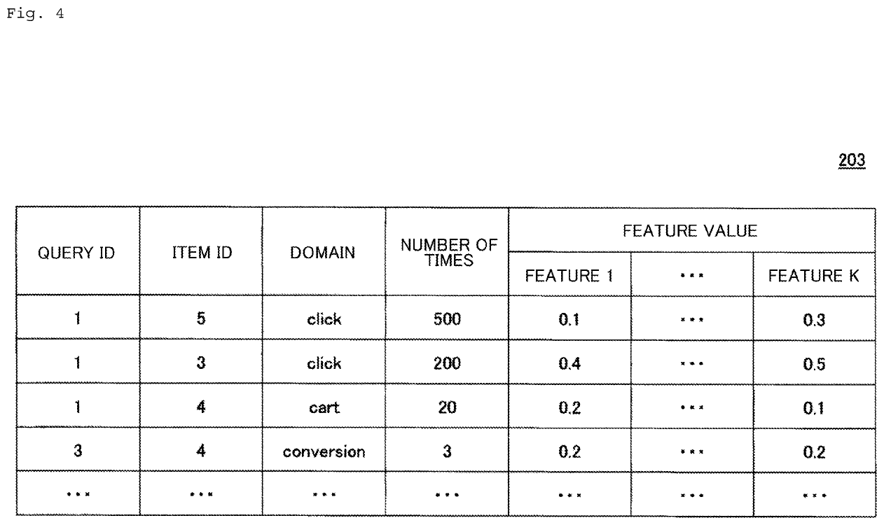

Next, referring to FIG. 3, the relational feature value data stored in the relational feature value DB 202 will be described. FIG. 3 is a diagram illustrating an example of the relational feature value DB 202.

As illustrated in FIG. 3, in the relational feature value DB 202, one or more records of relational feature value data are stored, and each record of the relational feature value data includes a query ID, an item ID, and a feature value. Here, the feature value is a value representing a feature of an item having the item ID, a feature of the item with respect to a search query having the query ID, and the like. Each record of the relational feature value data is used as an input (the feature value of the item) to the ranking function. In the following, by way of example, the number of features is denoted as K.

As such, each record of the relational feature value data is information representing, for each of the query IDs and the item IDs, feature values related to a search query having the query ID and an item having the item ID. Note that the feature value includes at least a feature value representing a feature of the item and a feature value representing a feature of the item with respect to the search query (in other words, a feature value representing a relationship between the search query and the item).

As the feature value representing the feature of the item, a feature value may be considered that is obtained by, e.g., extracting term frequency (TF) vectors from a document including a name of the item, a descriptive text for the item, a release date of the item, a category into which the item is classified, and the like, and producing, as the feature value, TF-IDF, a BM 25 score, or the like from these term frequency vectors. Also, as the feature value representing the feature of the item with respect to the search query, a feature value may be considered that is obtained by, e.g., extracting the term frequency vectors in the same manner as for the search query and producing the feature value described in, e.g., Reference Literature 1 “Wu, L., Hu, D., Hong, L., and Liu, H.: Turning clicks into purchases: Revenue optimization for product search in e-commerce, in The 41st International ACM SIGIR Conference on Research & Development in Information Retrieval, pp. 365-374 (2018)” or the like. However, these feature values are exemplary, and it is possible to use any feature value representing the feature of the item and any feature value representing the feature of the item with respect to the query.

Next, case data stored in the case DB 203 will be described with reference to FIG. 4. FIG. 4 is a diagram illustrating an example of the case DB 203.

As illustrated in FIG. 4, in the case DB 203, one or more records of case data are stored, and each record of the case data includes a query ID, an item ID, a domain, the number of times, and a feature value. Note that the domain means the type (i.e., any of “click”, “cart”, and “conversion”) of the user behavior.

As such, a record of the case data is data in which a query ID, an item ID, a domain, the number of times, and a feature value are associated with each other. In other words, each record of the case data is information representing, for each of the query IDs and the item IDs, the number of times a corresponding user behavior (user behavior corresponding to the domain) was performed with respect to the item having the item ID among the items included in the search result of the search query having this query ID, and feature values related to the search query having the query ID and the item having the item ID. Such case data is produced by connecting the search log data and the relational feature value data by using the same query ID and the same item ID.

The training pair production unit 102 uses the case data stored in the case DB 203 to produce training pair data to be stored in the training pair DB 204.

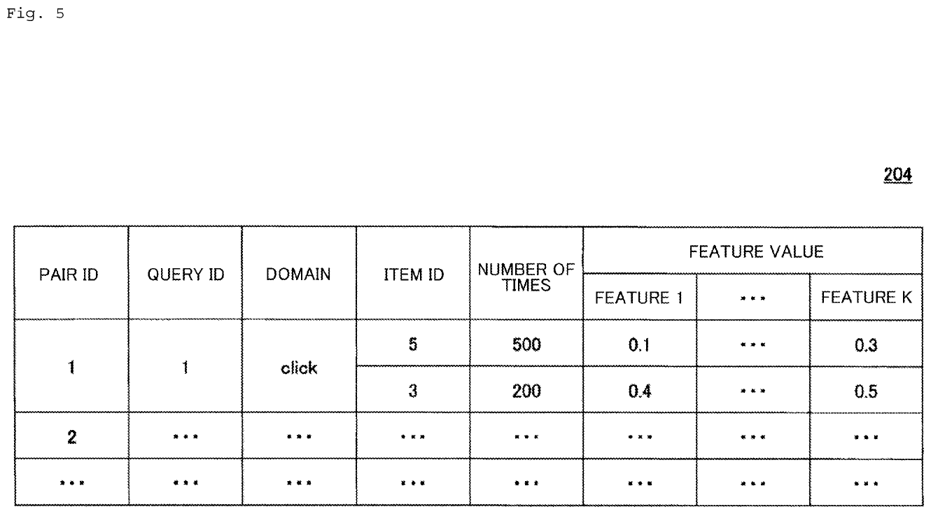

The training pair data stored in the training pair DB 204 will be described with reference to FIG. 5. FIG. 5 is a diagram illustrating an example of the training pair DB 204.

As illustrated in FIG. 5, in the training pair DB 204, one or more records of training pair data are stored, and each record of the training pair data includes a pair ID, a query ID, a domain, two item IDs, two numbers of times respectively corresponding to the two item IDs, and two feature values respectively corresponding to the two item IDs. Here, the pair ID is an ID for uniquely identifying the record of the training pair data.

Thus, a record of the training pair data is data in which a pair ID, a query ID, a domain, two item IDs, two numbers of times, and two feature values are associated with each other. Such a record of training pair data can be produced by connecting the two records of case data each having the same query ID and the same domain. For example, a record of training pair data having a pair ID “1” in FIG. 5 is produced by connecting a record of case data in the first row and a record of case data in the second row among the records of the case data in FIG. 4 by using the query ID “1” and the domain “click”.

Note that records of the training pair data stored in the training pair DB 204 are used as training data when the parameters of the neural network that implements ranking functions for the plurality of domains are learned.

The parameter learning unit 103 uses the records of the training pair data stored in the training pair DB 204 to learn the parameters of the neural network that implements the ranking functions for the plurality of domains. The learned parameters are stored in the parameter DB 205.

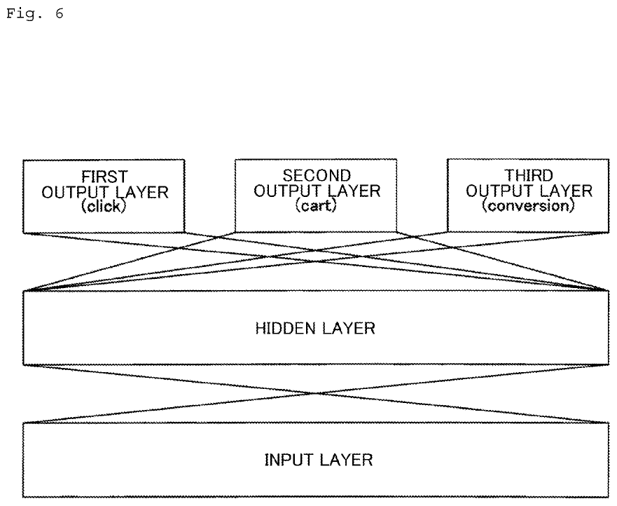

FIG. 6 illustrates an example of a configuration of the neural network that implements the ranking functions for the three domains “click”, “cart”, and “conversion”. As illustrated in FIG. 6, the neural network includes an input layer, a hidden layer, and three output layers, receives as input the feature values of the items, and outputs the ranks of the items. The dimensionality of the input layer is denoted as a number K (i.e., the dimensionality K of the feature values of the items) of the features of the items. The dimensionality of the hidden layer can be set to any value, and may be set to, e.g., 128. Among the three output layers, the first output layer corresponds to the domain “click”, the second output layer corresponds to the domain “cart”, and the third output layer corresponds to the domain “conversion”. The first output layer, the second output layer, and the third output layer output respective scholar values representing ranks of the items in the corresponding domains. One may consider determining the ranks of the items in descending order of, e.g., the scholar values.

<Ranking Function Generation Processing>

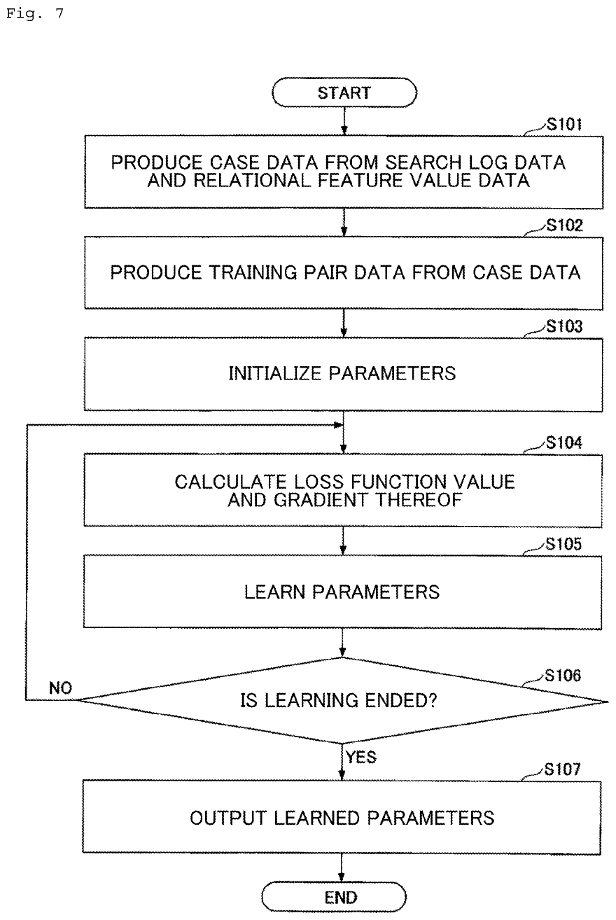

Next, processing of generating the ranking functions for the plurality of domains by using the ranking function generating apparatus 10 according to the present embodiment will be described with reference to FIG. 7. FIG. 7 is a flow chart illustrating an example of the ranking function generation processing according to the present embodiment. Note that Steps S101 and S102 in FIG. 7 may also be executed in advance before Step S103.

First, the case production unit 101 uses records of the search log data stored in the search log DB 201 and records of the relational feature value data stored in the relational feature value DB 202 to connect a record of the search log data and a record of the relational feature value data each having the same query ID and the same item ID to produce a record of the case data (Step S101). Then, the case production unit 101 stores the produced record of the case data in the case DB 203.

Next, the training pair production unit 102 connects the two records of case data each having the same query ID and the same domain among the records of the case data stored in the case DB 203, and assigns a number used as the pair ID to the connected case data to produce a record of training pair data (Step S102). Then, the training pair production unit 102 stores the produced record of the training pair data in the training pair DB 204.

Note that the training pair production unit 102 may produce a record of the training data for every pair of item IDs in records of the case data having the same query and the same domain or may also randomly select pairs of item IDs to produce records of the training data. Alternatively, the training pair production unit 102 may produce records of the training data for all combinations of the query IDs and the domains, or may also produce records of the training data for part of the combinations of the query IDs and the domains.

Next, the parameter learning unit 103 initializes the parameters of the neural network (hereinafter referred to also as the “learning target neural network”) that implements the ranking functions for the plurality of domains (Step S103). Note that, as the method for initialization, a known method may be used appropriately and, e.g., a method that initializes the parameters to random numbers according to a predetermined probability distribution or the like may be considered.

Next, the parameter learning unit 103 uses the records of the training pair data stored in the training pair DB 204 to calculate a loss function value to be used to update the parameters and a gradient related to the parameters (Step S104). Note that, as the method of calculating the gradient related to the parameters of the loss function, a known method may be used appropriately and, e.g., an error propagation method or the like may be used.

As the loss function value, L shown below is used.

$$L = {\sum }_{t ∈ τ} {w}_{t} {\sum }_{i , j ∈ {𝒟}_{t}} {L}_{ij}^{t} \qquad [ Math . 1 ]$$

where tϵT represents a domain (i.e., a user behavior), T={click, cart, conversion} is assumed, and wₜ represents a weight of a training pair in a domain t that takes a predetermined value. One may consider determining wₜ such that, e.g., when the weights wₜ of the training pairs in each domain t are added up as the inverse number of the number of records of the training pair data related to the domain, the resulting total number has an equal value (i.e., 1).

In addition, Dₜ represents a set of records of the training pair data related to the domain t, and i and j represent the two item IDs included in each record of the training pair data. Furthermore, the following expression is satisfied.

Lᵢⱼ^{t}=−P̅ᵢⱼ^{t} log Pᵢⱼ^{t}−(1−P̅ᵢⱼ^{t})log(1−Pᵢⱼ^{t}) [Math. 2]

Here, the following expression is satisfied.

$${P}_{ij}^{t} = P ( {x}_{i} {⊳}^{t} {x}_{j} ) = \frac{1}{1 + exp ( - {o}_{ij}^{t} )} \qquad [ Math . 3 ]$$

$${o}_{i j}^{t} \qquad [ Math . 4 ]$$

Note that the above expression represents a difference between an output value of a domain t obtained by inputting the feature value corresponding to an item ID “i” in a record of the training pair data to the learning target neural network. and an output value of the domain t obtained by inputting the feature value corresponding to an item ID “j” in the record of the training data to the learning target neural network. In other words, Pᵢⱼ^{t} represents a probability that, in the domain t, the item having the item ID “i” is ranked higher than the item having the item ID “j”.

In addition, the following expression is satisfied.

$${\overline{P}}_{ij} = \{ \begin{matrix}1 & if ( {y}_{i}^{q t} > {y}_{j}^{q t} ) \\ 0 & if ( {y}_{i}^{q t} < {y}_{j}^{q t} ) \\ \frac{1}{2} & if ( {y}_{i}^{q t} = {y}_{j}^{qt} )\end{matrix} \qquad [ Math . 5 ]$$

Note that yᵢ^{qt} represents the number of times corresponding to an item ID “i” in the record of training pair data, and yⱼ^{qt} represents the number of times corresponding to the item ID “i” in the record of training pair data. In other words, denoting the query ID included in the record of training pair data as q, yᵢ^{qt} represents the number of times that the user behavior corresponding to the domain t was performed with respect to the item having the item ID “i” included in the search result of the search query having the query ID “q”.

Next, the parameter learning unit 103 uses the loss function value L calculated in Step S104 described above and the gradient related to the parameters to update (learn) the parameters of the learning target neural network according to a known optimization method (Step S105). In other words, the parameter learning unit 103 updates the parameters according to the known optimization method so as to minimize the loss function value L. This means that the parameters are updated through multi-task learning by regarding the domain t as a task t.

Subsequently, the parameter learning unit 103 determines whether or not to end the learning of the parameters (Step S106). Note that the parameter learning unit 103 may appropriately determine that the learning of the parameters is to be ended when a predetermined ending condition is satisfied. Examples of the predetermined ending condition include that, e.g., Steps S104 to S105 described above have been repeated for a predetermined number of times or more, that the learning of the parameters has converged, and the like.

If it is not determined in Step S106 described above that the learning is to be ended, the parameter learning unit 103 returns to Step S104 described above. Thus, Steps S104 to S105 described above are repeatedly executed until the predetermined ending condition is satisfied.

On the other hand, if it is determined in Step S106 described above that the learning is to be ended, the parameter learning unit 103 stores the learned parameters in the parameter DB 205 (Step S107). Thus, the parameters of the learning target neural network are learned, and the neural network that implements the ranking functions for the plurality of domains is obtained. Accordingly, e.g., when it is desired to obtain the ranking function for the domain “conversion”, a neural network including the input layer, the hidden layer, and the third output layer may be used appropriately as the ranking function. Likewise, when it is desired to obtain the ranking function for the domain “click”, a neural network including the input layer, the hidden layer, and the first output layer may be used appropriately as the ranking function, and when it is desired to obtain the ranking function for the domain “cart”, a neural network including the input layer, the hidden layer, and the second output layer may be used appropriately as the ranking function.

<Evaluation Experiment>

Next, a result of an evaluation experiment for ranking functions generated by the ranking function generating apparatus 10 according to the present embodiment will be described. In this experiment, in the same manner as in the embodiment described above, it is assumed that the domains are “click”, “cart”, and “conversion”, and the number of search queries was set to 100. It was also assumed that a method of generating the ranking functions by using the ranking function generating apparatus 10 according to the present embodiment was “MULTI”, whereas comparative methods were “TARGET”, “MIX”, “TFIDF”, and “BM25”. Note that TARGET is a method of performing learning using records of training pair data only in a target domain (conversion), MIX is a method of performing learning by mixing domains without distinguishing the domains from one another, and each of TFIDF and BMF is a method of performing ranking on the basis only of a relation between the search query and the item.

As the evaluation index, MAP (Mean Average Precision), MRR (Mean Reciprocal Rank), and NDCG (Normalized Discounted Cumulative Gain), which are typical evaluation indices in learning for ranking, were used.

A result of this experiment is shown below in Table 1.

TABLE 1

| METHOD | MAP | MRR | NDCG |
|---|---|---|---|
| TARGET | 14.18% | 16.75% | 25.75% |
| MIX | 5.54% | 5.34% | 18.65% |
| MULTI | 15.19% | 17.81% | 27.02% |
| TFIDF | 13.60% | 16.84% | 25.71% |
| BM25 | 13.34% | 16.68% | 25.39% |

As shown above in Table 1, it can be understood that, according to MULTI, a high value was obtained in any of MAP, MRR, and NDCG compared to those obtained by the other comparative methods. Therefore, it can be stated that the ranking function generating apparatus 10 according to the present embodiment successfully generated a high-performance ranking function compared to those generated by the other comparative methods.

<Hardware Configuration>

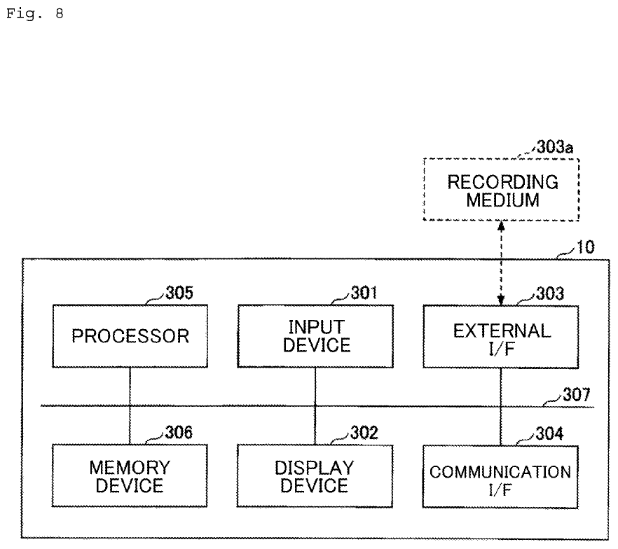

Finally, a hardware configuration of the ranking function generating apparatus 10 according to the present embodiment will be described with reference to FIG. 8. FIG. 8 is a diagram illustrating an example of a hardware configuration of the ranking function generating apparatus 10 according to the present embodiment.

As illustrated in FIG. 8, the ranking function generating apparatus 10 according to the present embodiment is implemented by a typical computer or computer system, and includes an input device 301, a display device 302, an external I/F 303, a communication I/F 304, a processor 305, and a memory device 306. These hardware components are communicably connected to each other via a bus 307.

The input device 301 is, e.g., a keyboard, a mouse, a touch panel, or the like. The display device 302 is, e.g., a display or the like. Note that the ranking function generating apparatus 10 does not need to have at least one of the input device 301 and the display device 302.

The external I/F 303 is an interface with an external device, such as a recording medium 303a. The ranking function generating apparatus 10 can perform reading, writing, or the like on the recording medium 303a via the external I/F 303. In the recording medium 303a, one or more programs that implement, e.g., the individual functional units (the case production unit 101, the training pair production unit 102, and the parameter learning unit 103) included in the ranking function generating apparatus 10 may also be stored. Note that examples of the recording medium 303a include a CD (Compact Disc), a DVD (Digital Versatile Disk), a SD memory card (Secure Digital memory card), a USB (Universal Serial Bus) memory, and the like.

The communication I/F 304 is an interface for connecting the ranking function generating apparatus 10 to a communication network. Note that the one or more programs that implement the individual functional units included in the ranking function generating apparatus 10 may also be acquired (downloaded) from a predetermined server device or the like via the communication I/F 304.

The processor 305 is one of various arithmetic/logic devices such as, e.g., a CPU (Central Processing Unit) and a GPU (Graphics Processing Unit). The individual functional units included in the ranking function generating apparatus 10 are implemented by, e.g., processing that the one or more programs stored in the memory device 306 cause a processor 505 to execute.

The memory device 306 is one of various storage devices such as, e.g., an HDD (Hard Disk Drive), an SSD (Solid State Drive), a RAM (Random Access Memory), a ROM (Read-Only Memory), and a flash memory. Each of the DBs (the search log DB 201, the relational feature value DB 202, the case DB 203, the training pair DB 204, and the parameter DB 205) included in the ranking function generating apparatus 10 can be implemented by the memory device 306. However, at least one of the individual DBs included in the ranking function generating apparatus 10 may also be implemented by a storage device (such as, e.g., a database server) connected to the ranking function generating apparatus 10 via the communication network.

By having the hardware configuration illustrated in FIG. 8, the ranking function generating apparatus 10 according to the present embodiment can implement the ranking function generation processing described above. Note that the hardware configuration illustrated in FIG. 8 is exemplary, and the ranking function generating apparatus 10 may also have another hardware configuration. For example, the ranking function generating apparatus 10 may include a plurality of processors 305 or may also include a plurality of memory devices 306.

The present invention is not limited to the specifically disclosed embodiment described above, and can be variously modified, changed, and combined with existing technologies without departing from the scope of claims.

### REFERENCE SIGNS LIST

10 Ranking function generating apparatus
101 Case production unit
102 Training pair production unit
103 Parameter learning unit
201 Search log DB
202 Relational feature value DB
203 Case DB
204 Training pair DB
205 Parameter DB
301 Input device
302 Display device
303 External I/F
303a Recording medium
304 Communication I/F
305 Processor
306 Memory device
307 Bus

1. A ranking function generating apparatus comprising:
a memory; and
a processor configured to execute:
producing training data including at least a first search log related to a first item included in a search result of a search query, a second search log related to a second item included in the search result, and respective domains of the first search log and the second search log; and
learning, using the training data, parameters of a neural network that implements ranking functions for a plurality of domains through multi-task learning regarding each of the domains as a task.

2. The ranking function generating apparatus according to claim 1, wherein
the neural network includes a plurality of output layers that output scholar values representing ranks of items in the plurality of individual domains, and
the learning learns the parameters so as to minimize a value of a loss function defined using a difference between a first output value from the neural network for the domains included in the training data and the first item and a second output value from the neural network for the domains and the second item and using the first search log and the second search log.

3. The ranking function generating apparatus according to claim 2, wherein the training data includes a feature value of the first item and a feature value of the second item,
wherein the first output value is an output value from the output layer corresponding to the domains included in the training data, among a plurality of output values output by inputting the feature value of the first item to the neural network, and
wherein the second output value is an output value from the output layer corresponding to the domains included in the training data, among a plurality of output values output by inputting the feature value of the second item to the neural network.

4. The ranking function generating apparatus according to claim 2, wherein the learning calculates, from the difference, a probability that the first item is ranked higher than the second item in one of the domains and calculates a value determined from the first search log and the second search log to calculate a value of the loss function and a gradient of the loss function related to the parameters, and
wherein the learning uses the value of the loss function and the gradient of the loss function related to the parameters to learn the parameters.

5. The ranking function generating apparatus according to claim 1, wherein each of the search logs is information representing the number of times a user behavior of a predetermined type was performed with respect to the item included in the search result of the search query, and
wherein the domain is the type of the user behavior corresponding to the search log.

6. A ranking function generating method, executed by a computer including a memory and a processor, the method comprising:
producing training data including at least a first search log related to a first item included in a search result of a search query, a second search log related to a second item included in the search result, and respective domains of the first search log and the second search log; and
learning, using the training data, parameters of a neural network that implements ranking functions for a plurality of domains through multi-task learning regarding each of the domains as a task.

7. A non-transitory computer-readable recording medium having computer-readable instructions stored thereon, which when executed, cause a computer to function as the ranking function generating apparatus according to claim 1.
